(19) United States
(12) Patent Application Publication
(10) Pub. No.: US 2026/0216943 A1
(43) Pub. Date: Jul. 30, 2026

(54) DEVICE FOR MOUNTING AND/OR DISASSEMBLING A SPINNER NOSE, AND APPLICATION TO A PREFORM THERMAL CONDITIONING UNIT

(71) Applicant: SIDEL PARTICIPATIONS, Octeville-sur-Mer (FR)

(72) Inventors: Sébastien FEVRE, OCTEVILLE-SUR-MER (FR); Emmanuel BONNAIRE, OCTEVILLE-SUR-MER (FR); Cyrille SAVARY, OCTEVILLE-SUR-MER (FR)

(21) Appl. No.: 19/144,332

(22) PCT Filed: Dec. 20, 2023
(86) PCT No.: PCT/EP2023/086863

§ 371 Date: Jun. 27, 2025

(30) Foreign Application Priority Data
Dec. 30, 2022 (FR) FR2214686

(51) Int. Cl. B29C 49/42; B25J 15/00; B29C 49/64

(52) U.S. Cl. CPC B29C 49/42065; B25J 15/0028; B29C 49/42071; B29C 49/6409

(57) ABSTRACT

Disclosed is a device for locking and/or unlocking at least one spinner nose mounted on a thermal conditioning unit. The thermal conditioning unit includes a frame, a preform conveying device that includes a plurality of supports and circulates along the frame, and a mandrel mounted on each support of the conveying device so as to be able to rotate about the longitudinal mandrel axis. Each mandrel has at least one attachment means that secures the spinner nose to the mandrel, the spinner nose being able to receive the plastic preform; The device further comprises means for locking and/or unlocking an attachment means securing the spinner nose to the mandrel and positioned in line with the conveying device.

### TECHNICAL FIELD OF THE INVENTION

The invention relates to a device for transporting and gripping a tubular preform with rotation of the preform about its main axis, more particularly in a thermal conditioning unit, as well as a clamp that is able and intended to be secured to a robotic arm and to cooperate with a conveying device. Another subject of the invention relates to a method for mounting and/or disassembling at least one spinner nose of a conveying device.

### PRIOR ART

The invention relates to the field of the manufacture of hollow bodies made of thermoplastic material, for which manufacture a preform is first produced by injection molding. The preform is then formed into a container in a container manufacturing facility.

For this purpose, the container manufacturing facility comprises a thermal conditioning unit, also known as an oven, in which the preform is thermally conditioned, and a blowing unit for obtaining the final container, in which the preform is formed by a blowing operation or by stretch-blowing operations.

A “hollow body” is a container preform, or a final container, or possibly an intermediate container, i.e. any type of hollow body including a body from which an open tubular neck extends.

In the remainder of the document, the term preform will be used preferably and in a non-limiting manner.

The preform usually has a tubular cylindrical body which is closed at one of its axial ends and which is extended at its other end by a neck, which is likewise tubular.

The neck extends axially from an annular main flange which is arranged at the junction of the neck and the body of the preform, to an annular lip, also called a mouth, which delimits an axial opening of the neck.

The body of the preform is required to undergo a plastic deformation in order to form the final container during the blowing operation. In order to be able to carry out this blowing operation, it is necessary for the body of the preform to be brought to a temperature higher than the glass transition temperature of the material. To this end, the preform is thermally conditioned by circulating it inside an oven, by means of a conveying device, along a heating path. The oven includes heating means which are for example constituted by infrared lamps or laser diodes in front of which the preforms are moved by the conveying device.

As the preform moves through the oven, it is advantageously driven in rotation about its main axis to ensure uniform heating.

The preforms are generally held on the conveying device by gripping means.

The preform is transferred to, or loaded at, the entrance to the oven by means for transferring the preform from a preform feed device to the conveying device.

The operation consisting of grabbing a preform with the gripping devices is called “loading”.

Similarly, at the exit of the oven, the operation consisting of unloading the heated preform from the gripping devices is called “unloading”.

Conventionally, the transport devices grab the preforms by the inside face of the neck using the gripping means. The gripping means are then driven in a vertical downward movement along the main axis of the preform relative to the transfer means in order to allow insertion of the gripping means into the neck. For this purpose, the transport devices circulate above the transfer means.

Conversely, the preforms are detached from the conveying device by pushing the mouth of the preform with an ejection face of the ejector and raising the gripping means along the main axis of the preform relative to the transfer means in order to enable separation of the gripping means from the neck.

The trajectory of a preform carried by the transfer means is usually tangential to the trajectory of the transport devices at one point or, at best, the two trajectories overlap over a short distance. This overlapping zone at one point or over a short distance is hereinafter referred to as the “loading zone”.

In order for the loading operation to take place, the gripping means must be synchronized with the transfer means so that the gripping means are actuated exactly in line with the loading zone. Similarly, in order for the unloading operation to take place, the gripping means must be synchronized with the transfer means so that the gripping means are actuated exactly in line with the unloading zone.

Such gripping means are well known, notably from European patent EP0935572, which describes a device for transporting and gripping preforms.

Said conveying device includes:
a vertical-axis support;
an axial mandrel mounted pivotingly and slidingly relative to the vertical-axis support, said vertical axis being coaxial with the axis of the mandrel;
a spinner mounted on one end of the mandrel, and which comprises:
a spinner nose that is removably fastened to one of the ends of the mandrel and that is capable of grabbing a preform.

Alternatively, the spinner comprises:
a spinner nose that is removably fastened to one of the ends of the mandrel and that is capable of grabbing a preform, and
an ejector at least partially surrounding the spinner nose that is secured to the vertical-axis support by a fastening means and that is capable of ejecting a preform.

A given facility must be able to manufacture containers of different models, and notably of different capacities. A given model of preform may be suitable for several models of containers, but not all. The oven must also be able to heat different models of preforms.

Preforms are not only distinguished by the shapes (and sizes) of their bodies, but may also have necks of different diameters.

It will therefore be readily understood that it is therefore necessary to replace each spinner nose with another spinner nose of a diameter suited to the new model of preform to be heated.

The spinner nose is usually fastened to the mandrel by means of a bayonet mounting. This mounting is commonly in the form of a bayonet socket. This bayonet socket comprises a slot extending parallel to the longitudinal axis of the mandrel, into which a pin integral with the spinner nose engages. To disassemble the spinner nose, the pin must be disengaged from the socket.

However, the operation for disassembling a set of spinner noses is quite long. Indeed, to change format, it is necessary to disassemble all the spinner noses of the thermal conditioning unit. Consequently, for a thermal conditioning unit with two hundred spinner noses, it takes four hours for an experienced operator to make this change.

### SUMMARY OF THE INVENTION

The invention proposes, according to a first subject, a device for locking and/or unlocking at least one spinner nose, mounted on a thermal conditioning unit including at least:
a frame;
a device for conveying preforms including a plurality of supports, said conveying device circulating along the frame along a predetermined trajectory (T);
a mandrel mounted movably in rotation about its longitudinal axis on each support of the conveying device, each mandrel comprising at least:
a first end provided with a fastening means securing the spinner nose to the mandrel, said spinner nose being able to receive the plastic preform;
another portion of the mandrel, opposite said first end, secured to a drive member for rotating said mandrel.

The device for locking and/or unlocking at least one spinner nose according to the invention is characterized in that it further comprises a means for locking and/or unlocking said fastening means securing the spinner nose to the mandrel and positioned in line with the conveying device.

According to another aspect of the invention, said locking and/or unlocking means is secured to said frame (23) of the conditioning unit.

According to another aspect of the invention, said fastening means comprises a male portion integral with said spinner nose and a female portion integral with said mandrel, said male portion having an annular slot, said female portion comprises balls capable of cooperating with said annular slot to lock the male portion and the female portion together, said female portion also comprising a peripheral cage provided with holes in which said balls are seated, and a lock provided with a ramp, said lock being mounted about said peripheral cage, movable between a locking position in which said balls cooperate with said annular slot and a release position in which said balls do not cooperate with the annular slot, but cooperate with said ramp.

According to another aspect of the invention, said fastening means comprises a female portion integral with said spinner nose and a male portion integral with said mandrel, said male portion having an annular slot, said female portion comprises balls capable of cooperating with said annular slot to lock the male portion and the female portion together, said female portion also comprising a peripheral cage provided with holes in which said balls are seated, and a lock provided with a ramp, said lock being mounted about said peripheral cage, movable between a locking position in which said balls cooperate with said annular slot and a release position in which said balls do not cooperate with the annular slot, but cooperate with said ramp.

According to another aspect of the invention, said lock comprises a skirt, a flange of which the diameter is smaller than said skirt, said skirt and said flange are connected by an intermediate shoulder, said intermediate shoulder and a free end of the flange define a bearing surface intended to actuate said lock.

According to another aspect of the invention, said fastening means comprises a male portion integral with said spinner nose and a female portion integral with said mandrel, said male portion having at least one stud at one of its ends, said female portion comprises at least two jaws capable of cooperating with said stud, and a lock cooperating with said jaws to actuate them, said lock being mounted about said female portion and movable between a locking position in which the jaws clamp said stud, and a release position in which the jaws are separated from said stud.

According to another aspect of the invention, said lock comprises a flange secured to a sliding peg inside the female portion that is capable of actuating said jaws, said flange includes a bearing surface intended to actuate said lock.

According to another aspect of the invention, the locking and/or unlocking means include a locking and/or unlocking member integral with a second actuator capable of moving said lock of said fastening means from its locking position to its release position.

According to another aspect of the invention, said locking and/or unlocking member includes a contact surface capable of cooperating with a bearing surface of said lock.

According to another aspect of the invention, the locking and/or unlocking means includes a positioning means capable of positioning said locking and/or unlocking means in line with said fastening means of said spinner nose.

According to another aspect of the invention, said positioning means comprises an actuator capable of moving said locking and/or unlocking means and/or a positioning member.

According to another aspect of the invention, said positioning member comprises a base fastened on one side to said first actuator and on the other side to a centering peg intended to cooperate with a centering hole positioned on said frame (23), as well as two branches, of which one end is secured to said base and the other end is secured to a shoe intended to bear against the conveying device to be disassembled.

According to another aspect of the invention, the locking and/or unlocking means includes a blocking means comprising a clamp consisting of two branches, which are movable with respect to each other, each branch being provided at its free end with a jaw insert capable of grabbing and holding the spinner nose.

According to another aspect of the invention, the clamp is mounted on a robotic arm.

According to another aspect of the invention, at least one branch of the clamp is driven by an actuator.

The invention proposes, according to a second subject, a method for locking and/or unlocking the spinner nose of a thermal conditioning unit including a device for locking and/or unlocking at least one spinner nose according to any one of the aforementioned aspects of the invention, including at least the following steps:
positioning said locking and/or unlocking means in line with said lock of the fastening means of said spinner nose,
actuating said lock to unlock the fastening means of the spinner nose.

### BRIEF DESCRIPTION OF THE FIGURES

Further features and advantages of the invention will become apparent on reading the detailed description that follows, for the understanding of which reference will be made to the appended drawings, which are described briefly below.

FIG. 1 is a schematic general view of a container production facility seen from above;

FIG. 2 is a detailed view of the inset in FIG. 1 showing a preform;

FIG. 3 is an overview of a conveying device;

FIG. 4 is an overview of another conveying device;

FIG. 5 is a general view of a spinner nose;

FIG. 6 is a sectional view of a ball fastening means for securing a mandrel to the spinner nose, in the locked position;

FIG. 7 is a sectional view of a ball fastening means for securing a mandrel to the spinner nose, in the released position;

FIG. 8 is a sectional view of a jaw fastening means for securing a mandrel to the spinner nose, in the locked position;

FIG. 9 is a sectional view of a jaw fastening means for securing a mandrel to the spinner nose, in the released position;

FIG. 10 is an overview of the device for locking and/or unlocking a spinner nose in the production position;

FIG. 11 is an overview of the device for locking and/or unlocking a spinner nose in the holding and unlocking position;

FIG. 12 is an overview of the device for locking and/or unlocking a spinner nose in the release position;

FIG. 13 is a view of a locking and/or unlocking member.

### DETAILED DESCRIPTION OF THE INVENTION

In the description below, elements with an identical structure or similar functions are denoted by the same reference sign.

Longitudinal, vertical and transverse orientations are used in a non-limiting manner with reference to the three-dimensional axes (L, V, T) shown in the figures.

By convention, the longitudinal and transverse directions are fixed relative to the molding devices such that the open or closed position occupied does not affect said orientations.

The terms “front” and “rear” are also used in a non-limiting manner with reference to the longitudinal orientation, as well as “upper” and “lower” with reference to the vertical orientation, and finally “left” or “right” and “inner” or “outer” with reference to the transverse orientation.

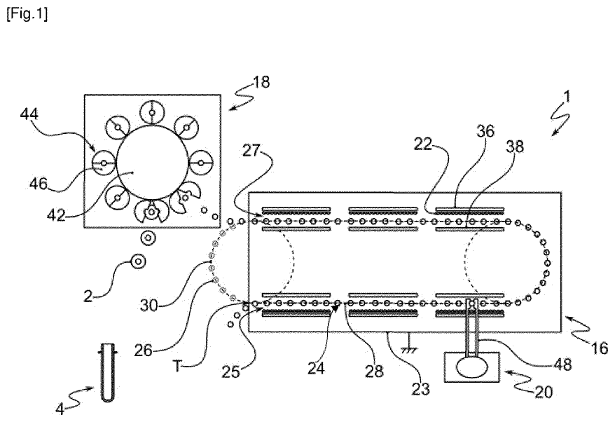

FIG. 1 is a schematic view of a facility 1 for the mass production of thermoplastic containers 2 from preforms 4.

In the remainder of the description, the preforms 4 and the containers 2 move through the production facility along a circulation path from upstream to downstream. The preforms 4 are moved in line along a heating path by conveying means, as detailed below.

In a nonlimiting manner, the containers in this instance are bottles. The thermoplastic material is, for example, formed in this instance by polyethylene terephthalate, referred to hereinafter by its acronym “PET”.

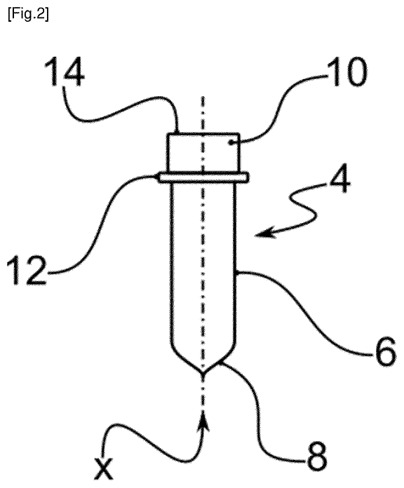

With reference to FIG. 2, such a preform 4 has a main axis “X” depicted vertically in the figure. It has a cylindrical body 6 with a tubular wall which is closed at one of its axial ends by a bottom 8 and which is open at its other end via a neck 10, which is also tubular. The neck 10 is delimited downward by a flange 12 and upward by an upper end edge referred to as a mouth 14.

The neck 10 is usually already in its final shape, whereas the body 6 of the preform is intended to be subjected to a relatively significant deformation to form the final container 2 during a forming step.

As shown in FIG. 1, the container manufacturing facility 1 comprises at least one thermal conditioning unit 16, a forming unit 18 and a manipulator 20.

The thermal conditioning unit 16, also referred to as an oven, enables a succession of preforms to be heated to a reference temperature. The reference temperature is chosen so that the body of each preform at the exit of a thermal conditioning unit 16 is in a malleable state allowing the body 6 of the heated preform to be deformed in order to form the container 2 in the forming unit. The reference temperature is between the glass transition temperature and the crystallization temperature of the plastic material of the preform. In the case of PET, the reference temperature is for example approximately 110°. The value of the reference temperature may vary according to the product with which the container is to be filled, or according to the technique used for filling the container. Thus, the reference temperatures for hot-filling and for a carbonated product are different, for example.

According to the embodiment shown in FIG. 1, the thermal conditioning unit 16 is a continuous oven through which the preforms 4 are transported in order to be exposed to a plurality of sources 22 of heating radiation.

To this end, the thermal conditioning unit 16 comprises a means 24 for conveying preforms circulating along a frame 23 through the thermal conditioning unit along a heating path between an entrance 25 and an exit 27 of the thermal conditioning unit, defining a trajectory T.

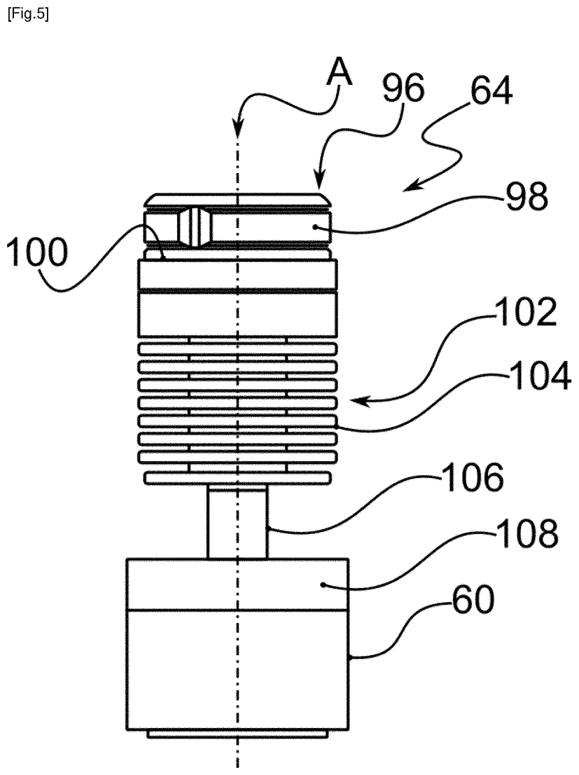

As depicted in FIGS. 1 and 5, the conveying means 24 comprises a succession of gripping devices 26, each able to support a preform, which are mounted on a chain 28 moving along the heating path. i.e. between the entrance and the exit for the preforms in the thermal conditioning unit. The chain circulates on wheels 30, at least one of which is motorized.

In another embodiment (not shown) the conveying means for example comprises a succession of gripping devices, each able to support a preform, which are mounted on a linear-motor shuttle circulating in a closed magnetic loop. The movement of each of these shuttles is controlled independently of the others by a control unit (not shown in the figures).

Each conveying device 26 is for example capable of receiving a preform by fitting the neck onto a spinner 32. Each spinner 32 is for example moveable in rotation with respect to the chain about an axis A of rotation coincident with the main axis X of a preform when this preform is being supported by the spinner.

The oven also comprises a heating cavity which comprises two side walls 36 facing each other, at least one of these walls supporting several radiation sources 22 arranged above and beside one another, facing the preforms.

In other words, the thermal conditioning unit 16 comprises a plurality of radiation sources 22 distributed along the path of the trajectory T and over a height corresponding substantially to the height of the preforms so that the entire height of the body of each preform is exposed to the radiation sources on the path of the preform in the thermal conditioning unit. By causing the preforms to rotate about their main axis X, the spinners 32 allow the entire body 6 of the preforms to be exposed uniformly to the radiation sources 22. In this particular embodiment, the radiation sources 22 are distributed on just one side of this path, and a reflective wall 38 is arranged on the other side of the heating path to reflect the heat back toward the preforms.

In another embodiment (not shown), the radiation sources 22 can be distributed on both sides of the heating path without thereby departing from the scope of the invention.

It should also be noted that the radiation sources 22 are arranged, if necessary, so as to ensure that the neck 10 is not exposed to the heat emitted by the radiation sources. Specifically, as indicated previously, only the body 6 of the preform 4 is heated to produce the container. As a result, the neck 10 must not be deformed during forming and must not be heated. To prevent the neck 10 from being heated, the oven may comprise a ventilation device positioned in line with the necks to evacuate any heat likely to be absorbed by the necks.

Each radiation source 22 is formed by an incandescent bulb emitting infrared radiation.

In another embodiment, each radiation source 22 is a laser diode emitting infrared radiation.

In other words, each radiation source 22 is a laser (for example laser diodes) emitting in the infrared and organized by juxtaposition and/or overlapping to form one or more matrices.

In another embodiment, each radiation source 22 is a microwave generator.

It is obvious that the radiation sources 22 could be any radiation source known to a person skilled in the art, or a combination of such radiation sources, without thereby departing from the scope of the invention.

Then, once the preform 4 has been thermally conditioned in the thermal conditioning unit 16, it is transferred to the forming unit 18 to be formed therein.

The unit 18 for forming containers 2 from preforms 4 is made up of a forming carousel 42 rotating a plurality of forming stations 44 from an entrance to an exit, where a succession of containers is formed from the preforms, before being removed, as shown in FIG. 1. The axis of rotation of the forming carousel is for example substantially parallel to the main axis X of the preforms when they are being transported by the forming carousel.

Each blowing station 44 comprises a mold 46 forming a molding cavity that has the shape of the container that is to be formed and is designed to accept a preform in such a way that the body of the preform extends into the molding cavity.

The container manufacturing facility 1 also comprises a manipulator 20 provided with a robotic arm 48 equipped at one of its ends with a clamp 50 for disassembling spinners 32. The assembly formed by the robotic arm and the clamp is movable at least partially vertically above the oven, to enable the spinners 32 to be disassembled.

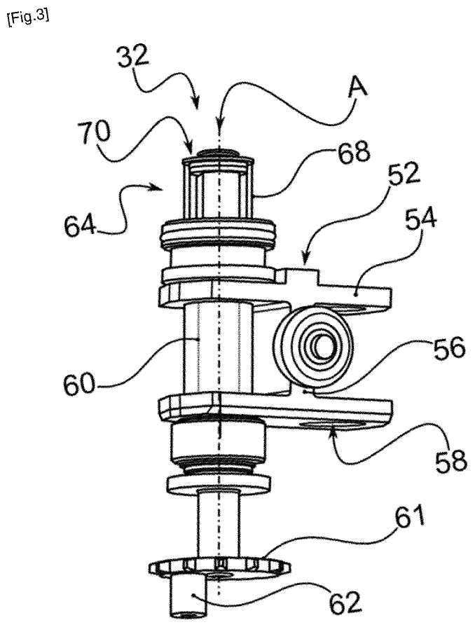

As shown in FIG. 3, the conveying device 26 comprises a support 52, also called a link in the figure, which is integrated into a chain which comprises a multitude of such links.

In this embodiment, the link, which is preferably metal (for example steel), comprises two superposed branches 54 which project laterally from a web 56. The branches contain coaxial holes 58 which jointly define a main axis.

The conveying device 26 further comprises:
a rotationally symmetrical mandrel 60 (visible in dotted lines in FIG. 3) mounted in the holes 58 of the link to form a sliding pivot connection with the link. Thus, the main axis of the holes and the axis of revolution of the mandrel 60 are coaxial;
a drive member 61 constrained to rotate with one of the free ends of the mandrel 60. In this embodiment, the drive member 61 is a pinion which is advantageously formed on an end piece in the form of a reel, force-fitted onto the mandrel 60;
a cam follower 62, in this instance a roller, secured to the drive member 61, said cam follower being off-centered with respect to the longitudinal axis of the mandrel 60 to angularly pre-orient each mandrel 60. In a variant, the cam follower 62 may be a finger;
a spinner 32 mounted on the other end of the mandrel 60 and comprising at least:
a spinner nose 64 which is removably fastened to the mandrel 60, in this case using a fastening means which is described below. The spinner nose 64 is intended to receive the neck of the preform;
an ejector 68 secured to the support 52. This ejector 68 has a substantially cylindrical shape and comprises at one of its ends at least one face 70 referred to as the ejection face of the preform;
The mandrel 60 and the spinner nose 64 extend coaxially with the ejector so that the free end of the spinner nose 64 projects from the ejector.

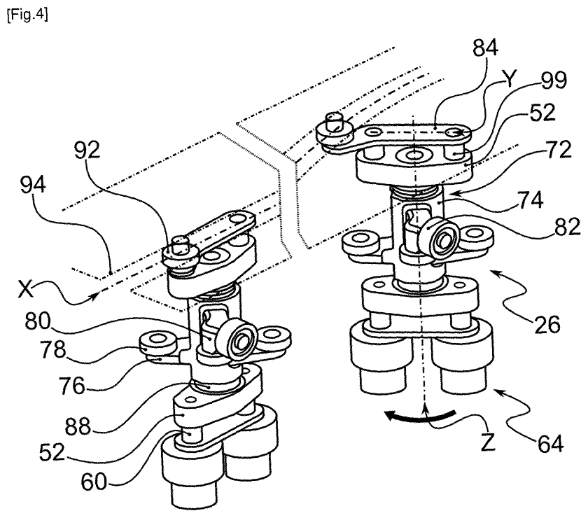

According to another embodiment illustrated in FIG. 4, the conveying device 26 comprises a carriage 72.

This carriage 72 comprises a central body 74 from which two lateral guide arms 76 project.

Each arm 76 carries, at one end, a lateral guide roller 78. The arms 76 are diametrically opposed and extend obliquely with respect to the direction of travel of the conveying device, so as to ensure dynamic balancing of the carriage 72 as it moves.

Furthermore, each carriage 72 preferably comprises vertical guide means formed by arms 80 projecting from the body 74 and carrying the rollers 82. These arms are advantageously diametrically opposed and extend obliquely with respect to the direction of travel of the conveying device 26, so as to ensure dynamic balancing of the carriage 72 as it moves.

To constrain the lever 84 to rotate with the support 52, each carriage 72 comprises a central shaft 88 mounted in rotation with respect to the body 74 of the carriage 72. In practice, the central shaft 88, which extends along the main axis Z of the carriage 72, is mounted in rotation in a bore made in the body 74.

The support 52 at a lower end of the shaft 88 comprises two spinner noses 64 which are each removably fastened to a mandrel 60, in this case using a fastening means which is described below. The spinner nose 64 is intended to receive the neck of the preform;

The lever 84 is mounted at an upper end of the shaft 88, and the support 52 is mounted at a lower end of the shaft 88. The lever 84 and the support 52 can be fastened to the shaft 88 by screwing.

This lever 84 is mounted articulated with respect to the carriage 72 between:
an unfolded position (visible on the left in FIG. 4) corresponding to the straight position of the support 52, and
an offset position (visible to the right in FIG. 4) corresponding to the oblique position of the support 52.

The lever 84 carries at one end a cam follower 92 capable of cooperating with a cam track 94. The unfolded position and the offset position depend on the position of the cam follower 92 with respect to the cam track 94.

Moreover, each carriage 72 can be coupled to its adjacent carriages by means of articulated connecting rods (not shown). Each connecting rod contains, at each of its ends, a cylindrical hole fitted onto a finger 99 integral with the central shaft 88, at the level of the lever 84 at the upper end of the shaft 88, and at the level of the support 52 at the lower end of the shaft 88, respectively.

According to a variant embodiment (not shown in the figures), the support 52 may be a linear motor comprising at least one bore in which the mandrel 60, the spinner nose 64 and the pinion are mounted slidingly and pivotingly, without thereby departing from the scope of the invention. With reference to FIG. 5, the spinner nose includes a cylindrical head 96 with a vertical axis “A”, the external diameter of which is slightly smaller than the internal diameter of the neck 10 of the preform such that there is a radial sliding clearance between the head and the neck 10 when the head 96 is fitted in the neck 10.

The head 96 comprises rings 98 which are in the form of annular sectors. Each ring 98 is received slidingly and radially in a radial seat of the head 96 between:
a position retracted toward the axis “A” of the head 96 allowing vertical sliding of the spinner relative to the neck 10 of the preform 4;
a radial expansion position in which they can be pressed against the inner cylindrical face of the neck 10 to hold the preform 4 in place by friction.
The rings 98 are elastically urged toward their expansion position by means of an elastic annulus which is interposed radially between the bottom of the seat made in the head 96 and the ring 98.

The head 96 is delimited vertically toward the bottom by a segment of larger diameter delimiting an annular shoulder face 100 which faces upwards and which forms a positioning face against which the mouth 14 is received in vertical abutment when the head 96 is fitted in the neck 10.

A radiator 102 is arranged under the head 96 and comprises fins 104 which have a generally cylindrical shape with a main vertical axis A, coaxial with the axis A of the head 96, the diameter of which is equivalent to the diameter of the section of greater diameter than the head 96.

A rod 106 is fastened at one of its ends to the radiator 102 and head 96 assembly, while the other end of the rod 106 is removably fastened to the mandrel 60, in this case by means of a fastening means 108 which will be described below.

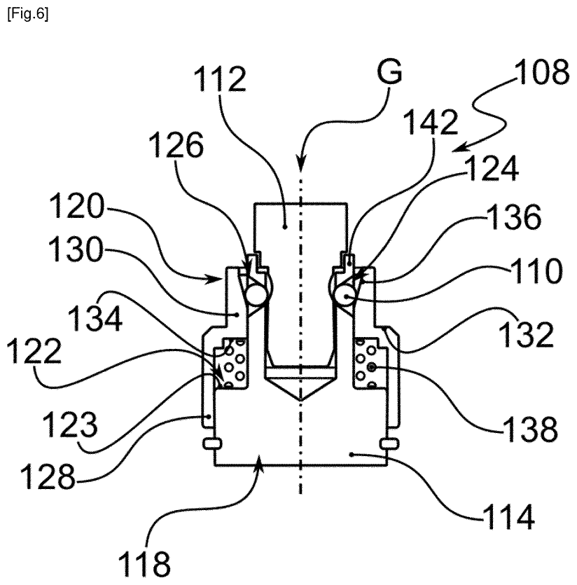

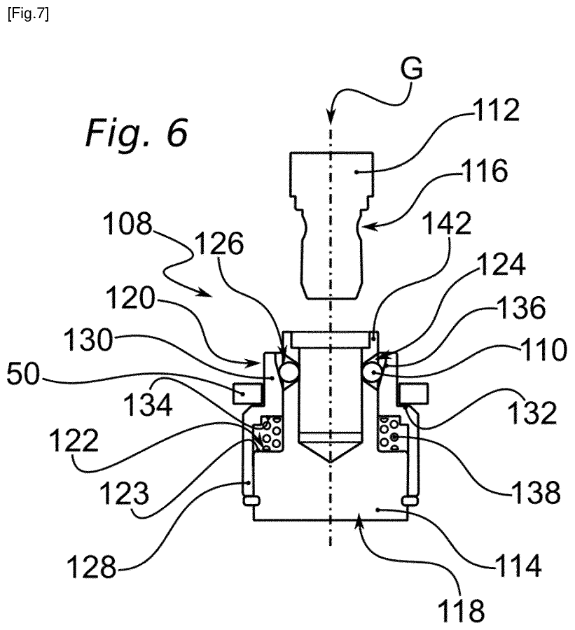

FIGS. 6 and 7 show a fastening means 108 using at least one ball 110 for securing the mandrel to the spinner nose. FIG. 6 depicts the fastening means 108 in a locking position and FIG. 7 depicts the fastening means 108 in a release position.

The fastening means 108 comprises a male portion 112 integral with the spinner nose or the mandrel and a female portion 114 integral with the mandrel or the spinner nose.

The male portion 112 has a cylindrical shape with an annular slot 116 at one of its free ends that can be inserted in the female portion 114.

The female portion 114 comprises balls 110 adapted to cooperate with the annular slot 116 to lock the male portion and the female portion together.

The female portion 114 comprises a peripheral cage 118 and a lock 120.

The peripheral cage 118 has a cylindrical shape of axis G, bored through its center, and at one of its ends the peripheral cage 118 extends radially so as to define a shoulder 122 defining an “upper” surface 123.

The cage 118 is provided with holes 124 in which the balls 110 are seated. These holes 124 are made orthogonally with respect to the axis G. They are cylindrical and have an inward counterbore 126 which locally restricts the section thereof, thereby limiting the radial travel of the balls 110 towards the inside.

The lock 120 is mounted moveably about the peripheral cage 118 between the locking position and the release position.

The lock 120 includes a skirt 128 and an annular flange 130, the diameter of which is smaller than the skirt. The annular flange 130 and the skirt 128 are connected by an intermediate shoulder 132 defining a “lower” surface 134.

The flange defines an inward frustoconical ramp 136 tapering upwards with respect to the axis G directed downwards.

A return spring 138 working in compression is mounted about the cage 118 by being interposed between the surface 134 and the surface 123 of the cage 118.

The lock 120 is thus axially moveable with respect to the axis G, by sliding the flange 130 on the cage 118, between a locking position (FIG. 6) in which the ramp 136 is in line with the balls 110 and exerts thereon a radial force directed towards the axis G, and a release position (FIG. 7) in which the ramp 136 is axially separated from the balls, and the balls are no longer cooperating with the annular slot 116.

In the embodiment illustrated in FIGS. 6 and 7, the return spring 138 bears against the “lower” surface 134 and the “upper” surface 123, working in compression and tending to separate these two surfaces. Thus, the lock 120 is urged permanently towards its locking position. To switch to the release position, it is necessary to move the lock 120 and, consequently, to stress the spring 138 by pressing on a bearing surface. The bearing surface is defined by the intermediate shoulder 132 or by a free end 142 of the flange.

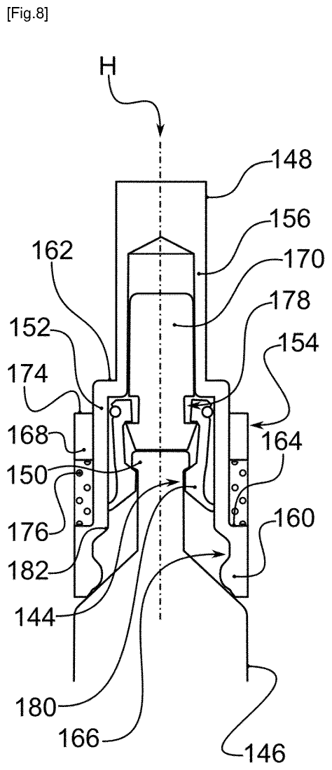

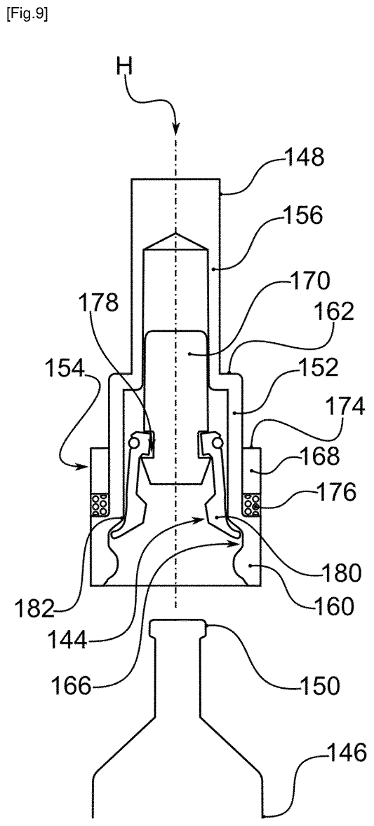

FIGS. 8 and 9 show a fastening means 108 comprising jaws 144 securing the mandrel to the spinner nose, one in a locking position and the other in a release position.

The fastening means 108 comprises a male portion 146 integral with the spinner nose and a female portion 148 integral with the mandrel.

The male portion has at least one stud 150 at one of these ends

The female portion 148 comprises at least two jaws 144 capable of cooperating with said stud 150.

The fastening means 108 comprises a peripheral cage 152 and a lock 154 for actuating the jaws.

The peripheral cage 152 is composed of three cylinders aligned with respect to one another along an axis H. These three cylinders are bored through their center with respect to the axis H. The external diameter of the first cylinder 156 is smaller than the external diameter of the second cylinder, and the latter has an external diameter smaller than the external diameter of the third cylinder 160. The junction between the first cylinder and the second cylinder forms a first shoulder 162 and the junction between the second cylinder and the third cylinder also forms a second shoulder 164. The third cylinder comprises an annular seat 166 on its inner wall capable of receiving a portion of each jaw.

The lock 154 is mounted moveably along the axis H about the peripheral cage 152 between a locking position and a release position.

The lock 154 is composed of a flange 168, a peg 170 and jaws 144.

The flange 168 and the peg 170 are constrained to move together by a mechanical connection, notably a pin.

The flange surrounds the cage 152 at the second cylinder and slides between the first shoulder 162 and the second shoulder 164.

This flange 168 comprises a lower surface and an upper surface 174. The upper surface 174 serves as a bearing surface for switching from the locked position to the release position.

A return spring 176 working in compression is mounted about the cage 152 by being interposed between the lower surface of the flange and the second shoulder 164 of the cage in order to hold the fastening means in the locked position.

The peg 170 is a cylinder coaxial with the axis H, the diameter of which is slightly smaller than the diameter of the first cylinder 156 forming part of the cage 152. This peg 170 has an annular slot 178 at the free end, i.e. the end not inserted in the first cylinder.

Each jaw 144 includes, at one of these ends, a section capable of cooperating with the annular slot 178 positioned on the peg 170 providing a pivot connection of the jaw. The jaw is held in the annular slot 178 by an elastic element such as a gasket or a spring. At the other end of the jaw there is a jaw insert 180 composed of a first portion intended to cooperate with the stud 150 of the male portion 146 and of a second portion 182 intended to cooperate with the cage 152 to rotate the jaw.

The lock 154 is thus axially moveable with respect to the axis H, by sliding the flange 168 on the cage and the peg 170 in the cage, also between a locking position (FIG. 8) in which each jaw 144 clamps the stud 150 of the male portion, and a release position (FIG. 9) in which each jaw is separated from the stud.

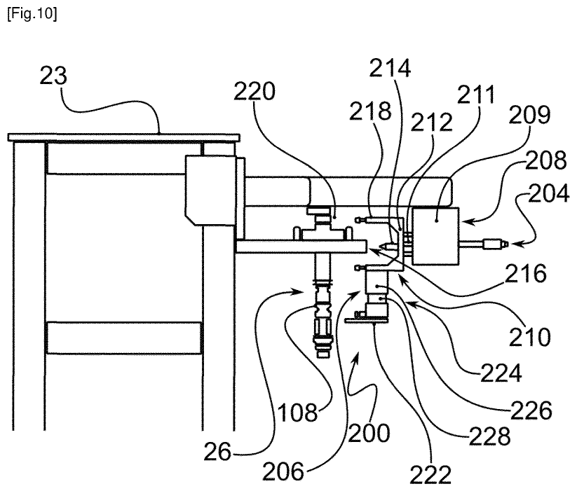

FIGS. 10 to 12 illustrate an overview of a device 200 for locking and/or unlocking at least one spinner nose fitted to a conveying device 26 positioned on the heating path of the thermal conditioning unit 16, i.e. at the wheels 30 or at the lateral walls 36.

The locking and/or unlocking device 200 is integral with the frame 23 of the thermal conditioning unit.

In the embodiment illustrated in FIGS. 10 to 12, the locking and/or unlocking device 200 comprises a positioning means 204 and a locking means 206.

The positioning means includes a first actuator 208 and a positioning member 210.

The first actuator 208 is capable of moving and positioning the positioning member 210, as well as the locking means 206.

The first actuator 208 is a hydraulic or pneumatic cylinder or any other actuator capable of moving the positioning member and/or the locking means in a horizontal direction.

The positioning means 204 comprises a cylinder 208 constituted by a body 209 fastened to the frame 23 and a piston 211 movable in translation in the horizontal direction and secured to the positioning member 210.

The positioning member 210 comprises a base 212 fastened on one side to the piston 211 and on the other side to a centering lug 214 intended to cooperate with a centering hole 216 positioned on the frame 23, as well as two branches 218, of which one end is secured to the base and the other end is secured to a shoe 220 intended to bear against the conveying device 26 to be disassembled.

In this embodiment, the locking means 206 is secured to one of the branches of the positioning means 204.

In another embodiment (not shown), the locking means 206 is secured to the piston of the first actuator 208.

The locking means 206 comprises a locking and/or unlocking member 222 integral with a second actuator 224 arranged so as to move the lock 120, 154 of the fastening means 108 from its locking position to its release position.

The second actuator 224 is also a hydraulic or pneumatic cylinder or any other actuator capable of moving the positioning member and/or the locking means in a vertical direction.

The cylinder 224 consists of a body 226 secured to one of the branches 218 of the positioning means and of a piston 228 to which the locking and/or unlocking member 222 is secured.

The locking and/or unlocking member 222 is positioned in line with the conveying device 26 and more particularly at the lock 120, 154 of the fastening means 108.

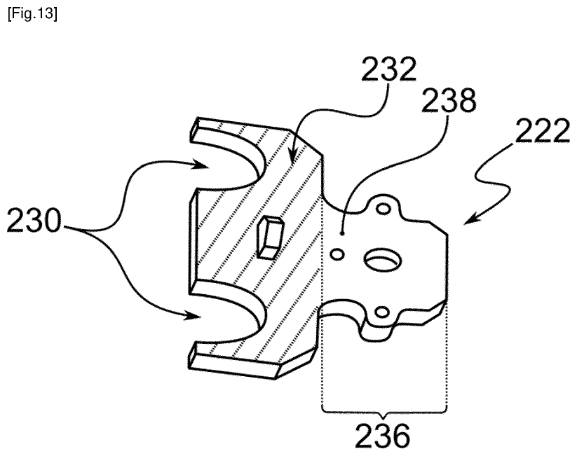

As shown in FIG. 13, the locking and/or unlocking member 222 is constituted by a plate 238 comprising a fastening section 236 fastened to the piston of the second actuator 224 and at least one notch 230, the upper surface of which is referred to as the “contact surface 232”, is colored black in FIG. 13, and is intended to cooperate with the lock 120, 154 of the fastening means 108.

In the embodiment illustrated in FIG. 13, there are two notches 230.

If the positioning of the conveying device 26 is precisely positioned relative to the frame 23 and to the locking means 206, the positioning member is not required. Consequently, in this other embodiment, the sole function of the positioning means 204 would be to position the locking means 206 in line with the conveying device, i.e. in an unlocking position.

FIGS. 10 to 12 show the kinematics of the device for locking and/or unlocking at least one spinner nose with respect to the conveying device.

FIG. 10 is an overview of a device 200 for locking and/or unlocking at least one spinner nose 64 in a production position.

The production position means that the locking and/or unlocking device 200 is not being used, thereby enabling the container production facility to produce containers.

The first actuator 208 is retracted and the second actuator 224 is in the extended position.

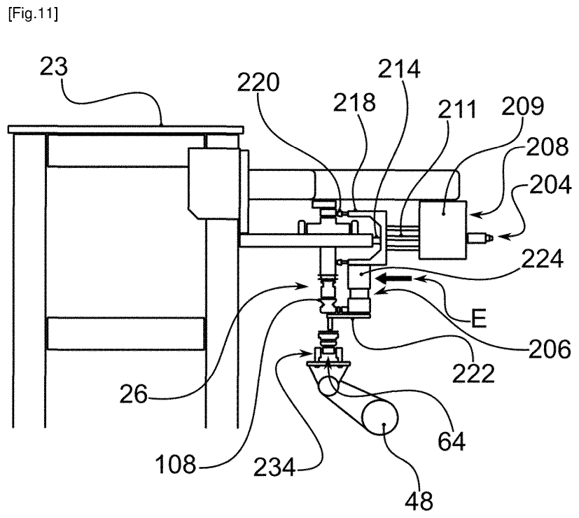

FIG. 11 is an overview of a device 200 for locking and/or unlocking at least one spinner nose 64 in the holding and unlocking position.

The holding and unlocking position means that the locking and/or unlocking device 200 is positioned to perform the operation of unlocking the fastening means 108, i.e. the first actuator 208 is deployed by means of the horizontal movement represented by arrow E. Consequently, the shoes 220 and the centering lug 214 are positioned respectively on the conveying device 26 and in the centering hole 216 located on the frame 23 of the thermal conditioning unit 16, and the locking and/or unlocking member 222 is positioned in line with the bearing surface at the lock 120, 154 of the fastening means 108.

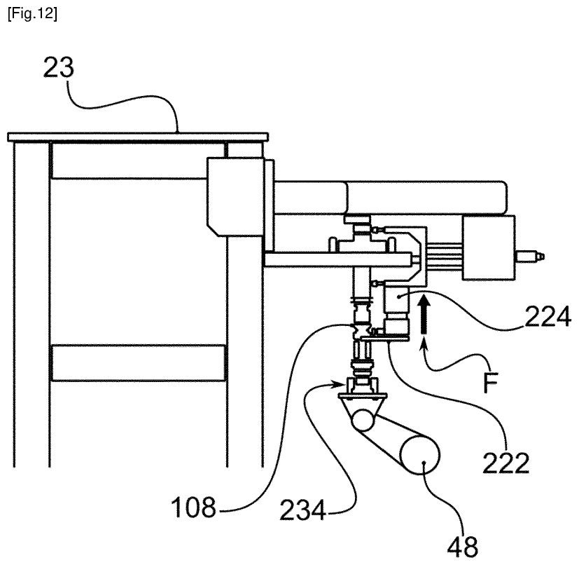

FIG. 12 is an overview of a device for locking and/or unlocking at least one spinner nose 64 in the release position.

The release position means that the locking and/or unlocking device is positioned to perform the operation of releasing the fastening means, i.e. the second actuator 224 is deployed by means of a vertical movement represented by the arrow F. Consequently, the locking and/or unlocking member 222 exerts a force on the bearing surface of the lock 120, 154 to actuate the unlocking of the locking device of the fastening means 108.

The kinematics of the device for locking and/or unlocking is controlled by a control unit of the container production facility (not shown).

The locking and/or unlocking device 200 may also comprise a blocking means 234 integral with the frame 23 of the thermal conditioning unit, or outside the thermal conditioning unit, as shown in FIG. 1 by the robotic arm 48.

The blocking means 234 comprises a clamp 50 consisting of two branches, which are movable with respect to each other, each branch being provided at its free end with a jaw insert capable of grabbing the spinner nose 64 to prevent the rotation thereof.

This clamp 50 is mounted on the robotic arm 48, as shown in FIG. 1.

In a variant, the blocking means 234 comprises a cylinder constituted by a body fastened to the frame 23 and a piston that can be moved to bear against the spinner nose 64 in order to hold it. This embodiment is not shown in the figures.

In a variant, the blocking means 234 comprises a cylinder constituted by a body fastened to the frame 23 and a piston that can be moved to attract and hold the spinner nose 64 by magnetization. This embodiment is also not shown in the figures.

1. A device for locking and/or unlocking at least one spinner nose mounted on a thermal conditioning unit:
where the thermal conditioning unit comprises:
a frame;
a device for conveying preforms comprising a plurality of supports, said conveying device circulating along the frame along a predetermined trajectory; and
a mandrel mounted movably in rotation about its longitudinal axis on each support of the conveying device, each mandrel comprising at least:
a first end provided with a fastening means securing the spinner nose to the mandrel, said spinner nose configured to receive a plastic preform; and
another portion of the mandrel, opposite said first end, secured to a drive member for rotating said mandrel ,
wherein the locking and/or unlocking device further comprises a means for locking and/or unlocking said fastening means securing the spinner nose to the mandrel and positioned in line with the conveying device.

2. The device for locking and/or unlocking at least one spinner nose as claimed in claim 1, wherein said locking and/or unlocking means is secured to said frame of the thermal conditioning unit.

3. The device for locking and/or unlocking at least one spinner nose as claimed in claim 1, wherein said fastening means comprises a male portion integral with said spinner nose and a female portion integral with said mandrel, said male portion having an annular slot said female portion comprises balls configured to cooperate with said annular slot to lock the male portion and the female portion together, said female portion also comprising a peripheral cage provided with holes in which said balls are seated, and a lock provided with a ramp said lock being mounted about said peripheral cage movable between a locking position in which said balls cooperate with said annular slot and a release position in which said balls do not cooperate with the annular slot, but cooperate with said ramp.

4. The device for locking and/or unlocking at least one spinner nose as claimed in claim 1, wherein said fastening means comprises a female portion integral with said spinner nose and a male portion integral with said mandrel, said male portion having an annular slot said female portion comprises balls configured to cooperate with said annular slot to lock the male portion and the female portion together, said female portion also comprising a peripheral cage provided with holes in which said balls are seated, and a lock provided with a ramp said lock being mounted about said peripheral cage movable between a locking position in which said balls cooperate with said annular slot and a release position in which said balls do not cooperate with the annular slot but cooperate with said ramp

5. The device for locking and/or unlocking at least one spinner nose as claimed in claim 4, wherein said lock comprises a skirt, a flange of which has a diameter smaller than said skirt said skirt and said flange are connected by an intermediate shoulder, said intermediate shoulder and a free end of the flange define a bearing surface configured to actuate said lock.

6. The device for locking and/or unlocking at least one spinner nose as claimed in claim 1, wherein said fastening means comprises a male portion integral with said spinner nose and a female portion integral with said mandrel, said male portion having at least one stud at one of its ends, said female portion comprises at least two jaws capable of cooperating with said stud, and a lock cooperating with said jaws to actuate them, said lock being mounted about said female portion and movable between a locking position in which the jaws clamp said stud and a release position in which the jaws are separated from said stud.

7. The device for locking and/or unlocking at least one spinner nose as claimed in claim 6, wherein said lock comprises a flange secured to a sliding peg inside the female portion configured to actuate said jaws said flange comprises a bearing surface configured to actuate said lock.

8. The device for locking and/or unlocking at least one spinner nose as claimed in claim 3, wherein the locking and/or unlocking means comprise a locking and/or unlocking member integral with a second actuator configured to move said lock of said fastening means from its locking position to its release position.

9. The device for locking and/or unlocking at least one spinner nose as claimed in claim 8, wherein said locking and/or unlocking member comprises a contact surface configured to cooperate with a bearing surface of said lock.

10. The device for locking and/or unlocking at least one spinner nose as claimed in claim 1, wherein the locking and/or unlocking means comprises a positioning means configured to position said locking and/or unlocking means in line with said fastening means of said spinner nose.

11. The device for locking and/or unlocking at least one spinner nose as claimed in claim 1, wherein said positioning means comprises an actuator configured to move said locking and/or unlocking means and/or a positioning member.

12. The device for locking and/or unlocking at least one spinner nose as claimed in claim 11, wherein said positioning member comprises a base fastened on one side to said actuator and on the other side to a centering lug configured to cooperate with a centering hole positioned on said frame, as well as two branches, of which one end is secured to said base and the other end is secured to a shoe configured to bear against the conveying device to be disassembled.

13. The device for locking and/or unlocking at least one spinner nose as claimed in claim 1, wherein the locking and/or unlocking means comprises a blocking means comprising a clamp consisting of two branches, which are movable with respect to each other, each branch being provided at its free end with a jaw insert configured to grab and hold the spinner nose.

14. The device for locking and/or unlocking at least one spinner nose as claimed in claim 13, wherein the clamp is mounted on a robotic arm.

15. The device for locking and/or unlocking at least one spinner nose as claimed in claim 13, wherein at least one branch of the clamp is driven by an actuator.

16. A method for locking and/or unlocking a spinner nose of a thermal conditioning unit comprising a device for locking and/or unlocking at least one spinner nose, the method comprising at least the following steps:
positioning a locking and/or unlocking means of the locking and/or unlocking device in line with a lock of a fastening means of said spinner nose; and
actuating said lock to unlock the fastening means of the spinner nose, wherein the fastening means secures the spinner nose to a mandrel and is positioned in line with a conveying device of the thermal conditioning unit,
wherein said fastening means comprises a male portion integral with said spinner nose and a female portion integral with said mandrel, said male portion having an annular slot, said female portion comprises balls configured to cooperate with said annular slot to lock the male portion and the female portion together, said female portion also comprising a peripheral cage provided with holes in which said balls are seated, and a lock provided with a ramp, said lock being mounted about said peripheral cage, movable between a locking position in which said balls cooperate with said annular slot and a release position in which said balls do not cooperate with the annular slot, but cooperate with said ramp.
